(19) United States
(12) Patent Application Publication
(10) Pub. No.: US 2018/0285317 A1
(43) Pub. Date: Oct. 4, 2018

(54) MODEL GENERATION SYSTEM AND MODEL GENERATION METHOD

(71) Applicant: Kabushiki Kaisha Toshiba, Minato-ku (JP)

(72) Inventors: Yukihito Nishida, Yokohama (JP); Hideki Yasui, Ota (JP)

(73) Assignee: Kabushiki Kaisha Toshiba, Minato-ku (JP)

(21) Appl. No.: 15/922,262

(22) Filed: Mar. 15, 2018

(30) Foreign Application Priority Data
Mar. 29, 2017 (JP) 2017-064791
Dec. 26, 2017 (JP) 2017-249728

(51) Int. Cl. G06F 17/15; G06F 17/50

(52) U.S. Cl. CPC G06F 17/153; G09G 1/162; G06F 17/5018

(57) ABSTRACT

According to one embodiment, a model generation system includes a base model generator, a similarity calculator, a modified model generator, and a generalization ability calculator. The base model generator generates a base model of a relationship between an input variable group and an output variable. The input variable group includes selected input variables selected from input variables. The similarity calculator calculates each similarity between the selected input variables and unselected input variables. The unselected input variables is included in the input variables. The modified model generator interchanges at least a portion of the plurality of selected input variables with at least a portion of the plurality of unselected input variables to generate another input variable group. The modified model generator generates a modified model of a relationship between the output variable and the other input variable group. The generalization ability calculator calculates generalization abilities of the models.

### CROSS-REFERENCE TO RELATED APPLICATIONS

This application is based upon and claims the benefit of priority from Japanese Patent Application No. 2017-064791, filed on Mar. 29, 2017; and Japanese Patent Application No. 2017-249728, filed on Dec. 26, 2017; the entire contents of which are incorporated herein by reference.

### FIELD

Embodiments described herein relate generally to a model generation system and a model generation method.

### BACKGROUND

To predict an output variable (a target variable) using multiple input variables (explanatory variables), it is common to generate a model of the relationship between the output variable and the multiple input variables. When generating the model, a portion of the input variables is selected from many input variables; and the model is generated by using the output variable and the selected input variables. For example, the input variables are selected so that the prediction error for the output variables is small, and the output variable can be predicted with higher accuracy.

Other than the accuracy, it is desirable for the generalization ability of a model to be high. In other words, it is desirable for a model generated based on data of some range (existing data) to have good accuracy even for data of another range (unknown data). However, a model that has high accuracy for the existing data does not always have a high generalization ability. Also, there are cases where the model that has superior generalization ability is a model that has somewhat lower accuracy for the existing data than does the model of the highest accuracy. Therefore, it is desirable to develop technology that can generate a model having a high generalization ability while suppressing the decrease of the accuracy.

### BRIEF DESCRIPTION OF THE DRAWINGS

FIG. 1 is a block diagram illustrating a configuration of a model generation system according to an embodiment;

FIG. 2A to FIG. 3B describe examples of the processing by the model generation system according to the embodiment;

FIG. 4 is a flowchart illustrating an example of the model generation method according to the embodiment;

FIG. 5 is a flowchart illustrating another example of the model generation method according to the embodiment;

FIG. 6 is a block diagram illustrating the configuration of a model generation device for realizing the model generation system according to the embodiment; and

FIGS. 7A, 7B, 8A, and 8B are graphs illustrating characteristics of the models generated using the model generation system according to the embodiment.

### DETAILED DESCRIPTION

According to one embodiment, a model generation system includes a base model generator, a similarity calculator, a modified model generator, and a generalization ability calculator. The base model generator generates a base model of a relationship between an input variable group and an output variable. The input variable group includes a plurality of selected input variables selected from a plurality of input variables. The similarity calculator calculates each similarity between the plurality of selected input variables and a plurality of unselected input variables. The plurality of unselected input variables is included in the plurality of input variables and is different from the plurality of selected input variables. The modified model generator interchanges, based on the plurality of similarities, at least a portion of the plurality of selected input variables with at least a portion of the plurality of unselected input variables so as to generate another input variable group. The modified model generator generates a modified model of a relationship between the output variable and the other input variable group. The generalization ability calculator calculates generalization abilities of the base model and the modified model.

Embodiments of the invention will now be described with reference to the drawings.

In the drawings and the specification of the application, components similar to those described thereinabove are marked with like reference numerals, and a detailed description is omitted as appropriate.

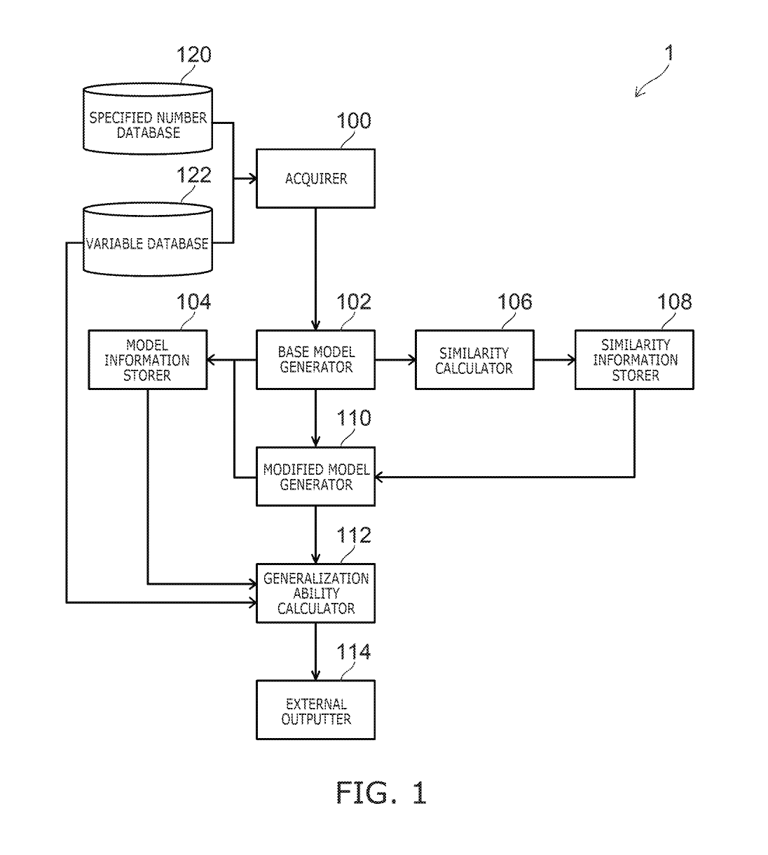

FIG. 1 is a block diagram illustrating a configuration of a model generation system 1 according to an embodiment.

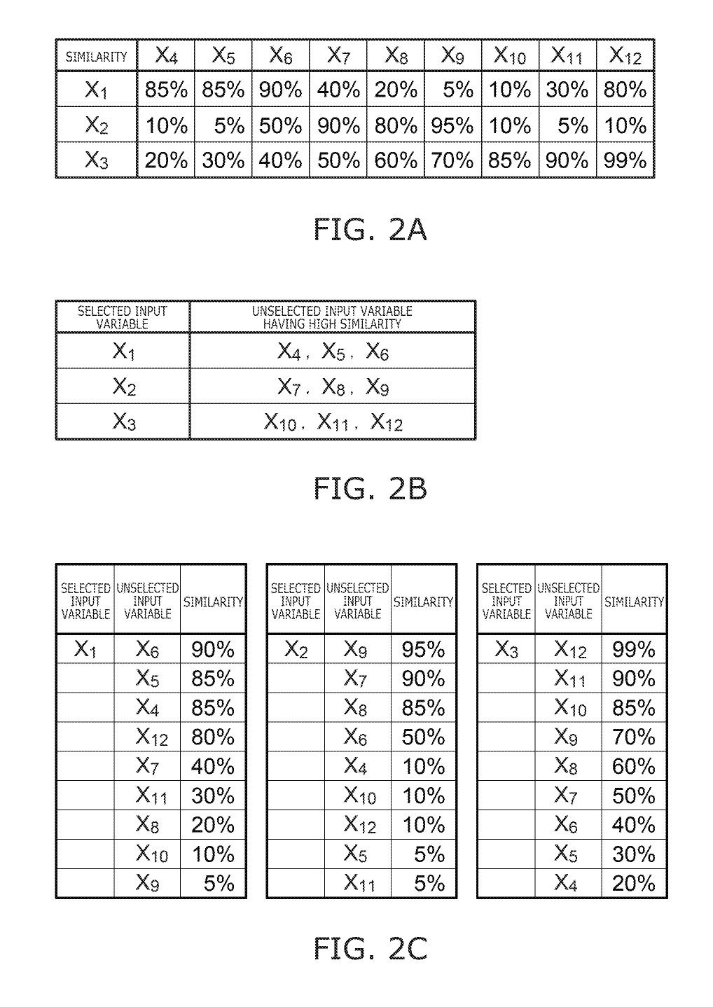

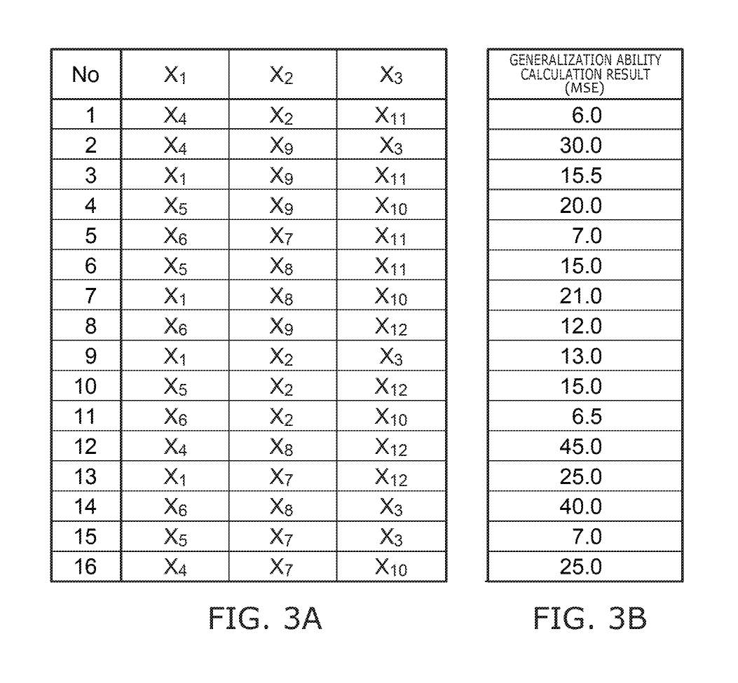

FIG. 2A to FIG. 3B describe examples of the processing by the model generation system 1 according to the embodiment.

As illustrated in FIG. 1, the model generation system 1 includes an acquirer 100, a base model generator 102, a model information storer 104, a similarity calculator 106, a similarity information storer 108, a modified model generator 110, a generalization ability calculator 112, an external outputter 114, a specified number database 120, and a variable database 122.

The specified number database 120 stores a specified number. The specified number indicates the number of models generated in the model generation system 1. For example, the specified number is pre-input by a user. The variable database 122 stores variable data which is the actual measured values of the variables for the input variables and the output variable.

The acquirer 100 acquires the specified number and the variable data respectively from the specified number database 120 and the variable database 122. The acquirer 100 outputs the acquired information to the base model generator 102.

The base model generator 102 selects a portion of input variables from the multiple input variables output from the acquirer 100. The base model generator 102 generates the model of the relationship between the output variable and the selected input variables by using the variable data acquired by the acquirer 100. For example, Least Absolute Shrinkage and Selection Operator (Lasso), Elastic Net, Ridge, Least Angle Regression (LARS), Non Negative Garrote, or Smoothly Clipped Absolute Deviation (SCAD) is used in the selection of the input variables and the generation of the model. Or, one of stepwise, Variable Important in the Projection (VIP), a genetic algorithm, or the Nearest Correlation Louvain Method (NCLM) may be used in the selection of the input variables; and a multiple regression or Partial Least Squares (PLS) may be used in the generation of the model.

Hereinbelow, the input variables that are selected in the model generation by the base model generator 102 are called the “selected input variables.” The variables that are not selected are called the “unselected input variables.” The selected input variables are a portion of the multiple input variables acquired by the acquirer 100. The unselected input variables are another portion of the multiple input variables. The unselected input variables are different from the selected input variables. The model that is generated by the base model generator 102 using the multiple selected input variables is called the “base model.” The base model is of the relationship between the output variable and the input variable group including the multiple selected input variables. The base model generator 102 outputs the generated base model to the model information storer 104. Thereby, the model information is stored in the model information storer 104. The base model generator 102 also outputs the base model to the similarity calculator 106 and the modified model generator 110.

The similarity calculator 106 calculates each similarity between the multiple unselected input variables and the selected input variables included in the base model. For example, a correlation coefficient, a partial correlation coefficient, a canonical correlation, a ridge determination coefficient, etc., can be used as the similarity. The similarity calculator 106 outputs the calculated similarity to the similarity information storer 108.

The modified model generator 110 acquires the similarity information of the input variables from the similarity information storer 108. Based on the similarity information, the modified model generator 110 interchanges at least a portion of the multiple selected input variables with at least a portion of the multiple unselected input variables. Thereby, another input variable group is generated. The modified model generator 110 may interchange all of the multiple selected input variables included in the base model with at least a portion of the multiple unselected input variables. The modified model generator 110 may interchange a portion of the multiple selected input variables included in the base model with all of the multiple unselected input variables. The modified model generator 110 generates models of the relationship between the output variable and the other input variable group recited above. Hereinbelow, these models that are generated by the modified model generator 110 are called the “modified models.” The model information of the modified models generated by the modified model generator 110 is stored in the model information storer 104. The modified model generator 110 determines whether or not the total number of the modified models and the base model generated by the model generation system 1 has reached the specified number. In the case where the total number of the generated models has not reached the specified number, the modified model generator 110 repeatedly generates other modified models while interchanging the variables included in the modified model.

When the total number of the base model and the modified models reaches the specified number, the generalization ability of each generated model is calculated by the generalization ability calculator 112. The generalization ability calculator 112 acquires the model information (the base model and the modified models) stored in the model information storer 104 and acquires the variable data from the variable database 122. At this time, the generalization ability calculator 112 acquires variable data (unknown data) of a range that is different from when generating the base model and the modified models.

For example, the generalization ability calculator 112 applies the base model and the modified models to the input variables of the unknown data. The generalization ability calculator 112 compares the actual measured value of the output variable and the predicted value of each model and calculates the accuracy of the prediction as the generalization ability of each model.

As an example, the base model and the modified models are generated by using various data (temperature, pressure, and final quality) obtained by using one manufacturing apparatus for the input variables and the output variable. In such a case, each model is applied to the variable data obtained by using another manufacturing apparatus; and the accuracy of each model is calculated as the generalization ability of each model.

Or, the base model and the modified models are generated based on the variable data obtained by using one manufacturing apparatus in a prescribed interval. In such a case, each model may be applied to data obtained by using the one apparatus in another interval; and the accuracy of each model may be calculated as the generalization ability of each model.

For example, the generalization ability is calculated using the Mean Square Error (MSE), the Root Mean Square Error (RMSE), the determination coefficient (R²), the correlation coefficient, Akaike's Information Criterion (AIC), Bayesian Information Criterion (BIC), etc. The generalization ability calculator 112 outputs the calculation result of the generalization ability to the external outputter 114 for each model.

The external outputter 114 displays or outputs one of the base model or the modified models having the highest generalization ability on a display for the user or in a prescribed file format. The external outputter 114 may output multiple models including the model having the highest generalization ability.

Multiple specific examples will now be described with reference to FIG. 2A to FIG. 3B.

For example, the variable data of an output variable Y and twelve input variables Xᵢ (i being a natural number from 1 to 12) is stored in the variable database 122. In such a case, the base model generator 102 selects a portion of the twelve input variables. The base model generator 102 generates a base model represented by, for example, the following Formula (1) between the output variable Y and the portion of the multiple input variables. The base model generator 102 stores the base model in the model information storer 104.

Y=b₁X₁+b₂X₂+b₃X₃+b₀ (1)

The similarity calculator 106 calculates each of the similarities as illustrated in FIG. 2A between X₁, X₂, and X₃ which are the selected input variables and X₄ to X₁₂ which are the unselected input variables. The case where the correlation coefficient is used as the similarity is illustrated in FIG. 2A.

As a first method, for example, the modified model generator 110 uses a preset threshold. For each of the selected input variables, the modified model generator 110 extracts at least one unselected input variable having a similarity that is not less than the threshold.

In the example illustrated in FIG. 2B, the threshold is set to 80%; and unselected input variables having high similarities are extracted for each of the selected input variables. In other words, in the example, the variables X₄, X₅, and X₆ are extracted for the variable X₁. The variables X₇, X₈, and X₉ are extracted for the variable X₂; and the variables X₁₀, Xᵢᵢ, and X₁₂ are extracted for the variable X₃. Thereby, sets of one selected input variable and at least one unselected input variable having a high similarity with the one selected input variable are multiply generated. In the example illustrated in FIG. 2A, the similarity of the unselected input variable X₁₂ not less than 80% for both the selected input variables X₁ and X₃. In such a case, for example, the unselected input variable X₁₂ is assigned to the selected input variable X₃ for which the similarity is higher.

For example, the modified model generator 110 interchanges the selected input variables and the unselected input variables at a uniform probability for each of the sets. The modified model generator 110 generates the modified model based on the group of the selected input variables and the unselected input variables after the interchange. The modified model generator 110 stores the modified model in the model information storer 104. For example, in the example illustrated in FIG. 2A and FIG. 2B, the variables X₁ and X₃ are not interchanged; and the variable X₂ is interchanged with the variable X₇. In such a case, the modified model generator 110 generates the modified model represented by the following Formula (2) based on these input variables and stores the modified model in the model information storer 104.

Y=b₅X₁+b₆X₇+b₇X₃+b₄ (2)

As a second method, the modified model generator 110 sets the probabilities based on the similarities of the unselected input variables. The modified model generator 110 interchanges at least one selected input variable and at least one unselected input variable according to the probabilities. In FIG. 2C, the calculation results of the similarities illustrated in FIG. 2A are arranged for the selected input variables in order from high to low similarity for the unselected input variables. Probabilities Pⱼₖ of interchanging selected input variables Xⱼ (j=1, 2, and 3) and unselected input variables Xₖ (k=4 to 12) are set using the similarities of the unselected input variables by, for example, the following Formula (3). α is a numerical value set for the probability of not being interchanged. Sⱼₖ are similarities between the selected input variables Xⱼ and the unselected input variables Xₖ.

$${P}_{jk} = \frac{{S}_{jk}}{( α + {\sum }_{k} {S}_{jk} )} \qquad ( 3 )$$

The modified model generator 110 interchanges the selected input variables and the unselected input variables according to the probability represented by Formula (3). Similarly to Formula (2), the modified model generator 110 generates the modified model, and stores the modified model in the model information storer 104. Compared to the method described above, according to this method, the similarities are reflected more closely in the modified model that is generated. Accordingly, compared to the method described above, it is easier to generate the modified model using combinations of the input variables X so that the prediction error for the output variable is smaller.

As a third method, the modified model generator 110 may generate the modified model using experimental design. Specifically, as illustrated in FIG. 2B, the modified model generator 110 extracts the unselected input variables having high similarities for each of the selected input variables. By using experimental design as illustrated in FIG. 3A, the modified model generator 110 generates an orthogonal table and generates the modified models in order based on the orthogonal table. As illustrated in FIG. 3B, the generalization ability calculator 112 calculates the generalization ability (MSE) for each of the modified models generated based on the orthogonal table. The modified model generator 110 calculates the main effects due to interchanging the variables by referring to the calculation result of the generalization ability. Then, the modified model generator 110 generates a modified model by interchanging at least a portion of the multiple selected input variables with at least one unselected input variable having the largest main effect to maximize the generalization ability. The modified model generator 110 outputs the modified model to the outside.

When generating the orthogonal table in this method, the modified model generator 110 may determine whether or not the number of modified models generated based on the orthogonal table is not more than the specified number. In the case where the number of generated modified models is not more than the specified number, the generation of the modified models and the calculation of the main effects are performed according to the method described above. In the case where the number of generated modified models exceeds the specified number, for example, the model generation system 1 outputs an error from the external outputter 114, or generates the modified models by performing the replacement using the first or second method.

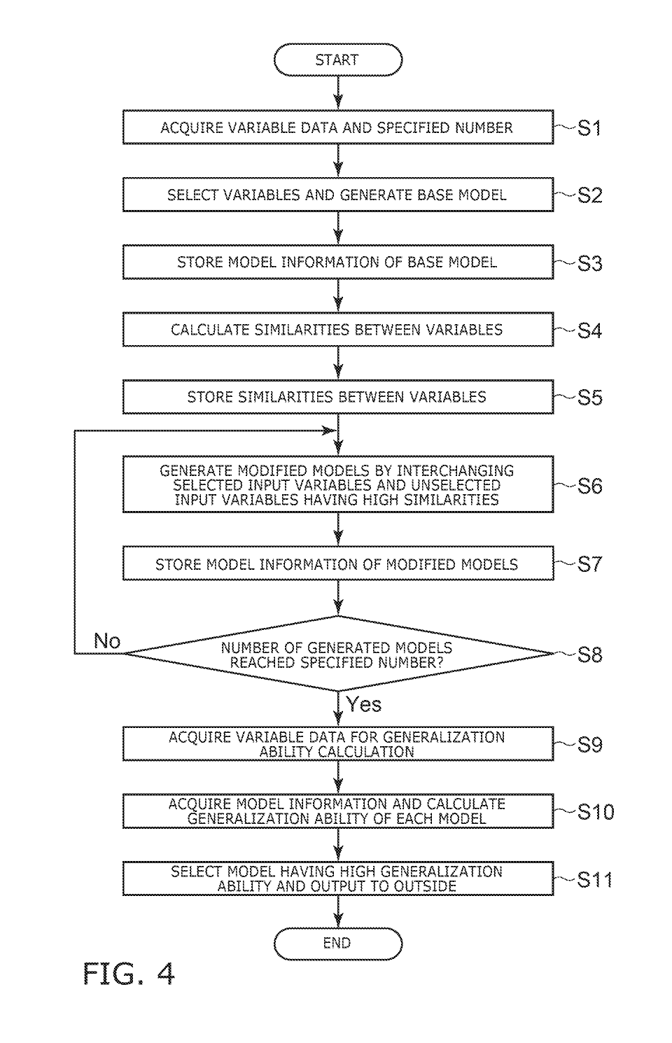

FIG. 4 is a flowchart illustrating an example of the model generation method according to the embodiment.

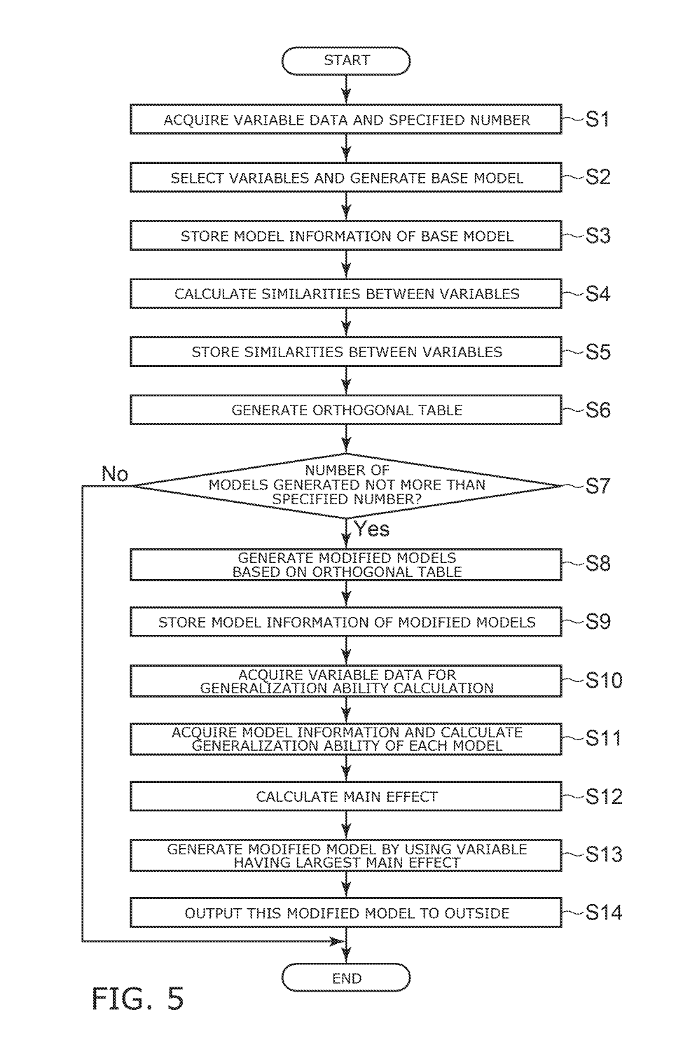

FIG. 5 is a flowchart illustrating another example of the model generation method according to the embodiment.

The flowchart illustrated in FIG. 4 corresponds to the first and second methods described using FIG. 2A to FIG. 2C. The flowchart illustrated in FIG. 5 corresponds to the third method described using FIGS. 3A to 3B.

The flowchart illustrated in FIG. 4 will now be described.

The acquirer 100 acquires the specified number and the variable data from the specified number database 120 and the variable database 122 (step S1). The base model generator 102 selects a portion of the multiple input variables and generates the base model (step S2). The base model generator 102 stores the model information of the generated base model in the model information storer 104 (step S3).

The similarity calculator 106 calculates each similarity between the multiple selected input variables selected to generate the base model and the multiple unselected input variables that are not selected (step S4). The similarity calculator 106 stores the calculated similarities between these variables in the similarity information storer 108 (step S5). The modified model generator 110 interchanges at least one selected input variable with at least one unselected input variable having a high similarity with the at least one selected input variable. The modified model generator 110 generates the modified models based on the input variable groups after the interchange (step S6).

The modified model generator 110 stores the model information of the generated modified models in the model information storer 104 (step S7). The modified model generator 110 determines whether or not the number of generated models has reached the specified number acquired in step S1 (step S8). In the case where the specified number has not been reached, steps S6 and S7 are performed repeatedly until the specified number is reached.

When the number of generated models has reached the specified number, the generalization ability calculator 112 acquires, from the variable database 122, the variable data for calculating the generalization abilities of the generated models (step S9). The generalization ability calculator 112 acquires the model information of the base model and the modified models from the model information storer 104 and calculates the generalization ability of each model (step S10). The external outputter 114 selects a model having a high generalization ability and outputs the model to the outside (step S11).

The flowchart illustrated in FIG. 5 will now be described.

Steps S1 to S5 are executed similarly to steps S1 to S5 of the flowchart illustrated in FIG. 4. The modified model generator 110 generates an orthogonal table based on the similarities stored in the similarity information storer 108 (step S6). The modified model generator 110 determines whether or not the number of modified models generated based on the orthogonal table is not more than the specified number (step S7). In the case where the number of modified models exceeds the specified number, the generation of the modified models using experimental design is ended. In the case where the number of modified models is not more than the specified number, the modified model generator 110 generates other modified models based on the orthogonal table (step S8).

The modified model generator 110 stores the model information of the generated modified models in the model information storer 104 (step S9). The generalization ability calculator 112 acquires, from the variable database 122, the variable data for calculating the generalization abilities of the generated models (step S10). The generalization ability calculator 112 acquires the model information of the base model and the modified models from the model information storer 104 and calculates the generalization ability of each model (step S11). The generalization ability calculator 112 calculates the main effects due to interchanging the variables by referring to the calculation result of the generalization ability (step S12). The modified model generator 110 generates another modified model by interchanging at least a portion of the multiple selected input variables with at least one unselected input variable having the largest main effect (step S13). The external outputter 114 outputs, to the outside, the other modified model generated in step S13 as the model having the highest generalization ability (step S14).

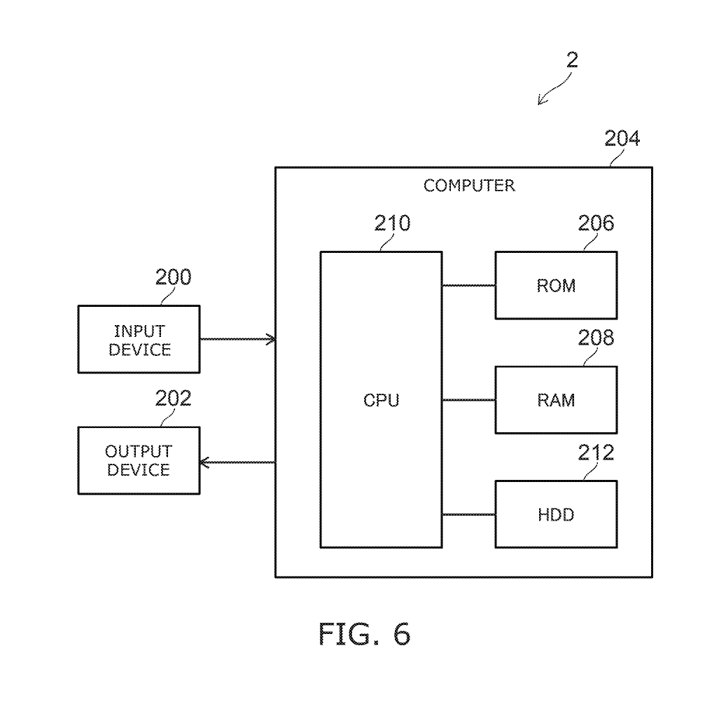

FIG. 6 is a block diagram illustrating the configuration of a model generation device 2 for realizing the model generation system 1 according to the embodiment.

The model generation device 2 includes, for example, an input device 200, an output device 202, and a computer 204. The computer 204 includes, for example, ROM (Read Only Memory) 206, RAM (Random Access Memory) 208, a CPU (Central Processing Unit) 210, and a memory device HDD (Hard Disk Drive) 212.

The input device 200 is for a user inputting information to the model generation device 2. The input device 200 is a keyboard, a touch panel, etc.

The output device 202 is for outputting the output result obtained by the model generation system 1 to the user. The output device 202 is a display, a printer, etc.

The ROM 206 stores a program controlling the operations of the model generation device 2. The ROM 206 stores a program necessary for causing the computer 204 to function as the acquirer 100, the base model generator 102, the similarity calculator 106, the modified model generator 110, the generalization ability calculator 112, and the external outputter 114 illustrated in FIG. 1.

The RAM 208 functions as the memory region where the program stored in the ROM 206 is loaded. The CPU 210 reads the control program stored in ROM 206 and controls the operations of the computer 204 according to the control program. The CPU 210 loads, into the RAM 208, various data obtained by the operations of the computer 204.

The HDD 212 stores the specified number database 120 and the variable database 122 illustrated in FIG. 1. The HDD 212 functions as the model information storer 104 and the similarity information storer 108 that store the generated models and the calculated similarities.

Effects of the embodiment described above will now be described.

According to the model generation system 1 according to the embodiment, the base model generator 102 generate a base model that can predict the output variable with high accuracy by using the input variable group including the multiple selected input variables. Then, based on each similarity between the multiple selected input variables and the multiple unselected input variables, at least a portion of the multiple selected input variables is interchanged with at least a portion of the multiple unselected input variables by the modified model generator 110. Thereby, another input variable group is generated. The modified model is generated using the other input variable group. By using the similarities to interchange the at least a portion of the multiple selected input variables and the at least a portion of the multiple unselected input variables, the modified model that is generated by using the other input variable group recited above also can predict the output variable with relatively high accuracy. Then, the generalization abilities are calculated by the generalization ability calculator 112 for the generated base model and modified model. At this time, as described above, it is possible to predict the output variable with relatively high accuracy by using the model having the highest generalization ability calculated by the generalization ability calculator 112.

In other words, according to the embodiment, a model having a high generalization ability can be generated while suppressing the decrease of the accuracy.

In the interchange of the selected input variables and the unselected input variables, for example, as illustrated in FIG. 2A and FIG. 2B, the unselected input variables for which the prescribed threshold is not less than are extracted. Then, the extracted unselected input variables are interchanged with the selected input variables by using probabilities. According to this method, the decrease of the accuracy of the modified model can be suppressed because only the selected input variables and unselected input variables having high similarities are used to generate the modified model.

Or, as illustrated in FIG. 2A and FIG. 2C, the probability of interchanging may be set for all of the unselected input variables based on the similarities; and at least a portion of the multiple selected input variables may be interchanged with at least a portion of the multiple unselected input variables according to the probabilities. The probability of the selected input variable being interchanged with the unselected input variable decreases as the similarity of the unselected input variable decreases. Therefore, in this method as well, the decrease of the accuracy of the modified model can be suppressed. According to this method, a model having a higher generalization ability can be generated because various modified models are generated.

Or, as illustrated in FIG. 3A and FIG. 3B, the generalization ability may be calculated by interchanging the variables based on an orthogonal table. The modified model is generated by interchanging a portion of the multiple selected input variables with at least a portion of the multiple unselected input variables to maximize the main effect. According to this method, a model having an even higher generalization ability can be generated while suppressing the decrease of the accuracy. According to this method, it is unnecessary to generate a modified model for all of the combinations of the selected input variables and the extracted unselected input variables; and a modified model having a high generalization ability can be generated efficiently in a shorter amount of time.

### First Example

A specific example will now be described.

In a first example, the final quality of a workpiece after processing was used as the output variable of a manufacturing apparatus of an electronic device. The data (the temperature, the pressure, etc.) of various sensors provided in the manufacturing apparatus was used as the input variables. The specified number was set to 100. Adaptive Lasso was used for the selection of the multiple input variables and the generation of the base model. The correlation coefficient between the selected input variables and the unselected input variables was used as the similarity. The unselected input variables for which the correlation coefficient is not less than 0.5 were extracted and used to interchange the selected input variables at a uniform probability. After interchanging the selected input variables and the unselected input variables, a multiple regression was used to generate the models. Each model was generated based on the variable data for a prescribed generation interval T0. The variable data of the intervals of test intervals T1 to T5 after the generation interval T0 are used to calculate the generalization ability for the same manufacturing apparatus.

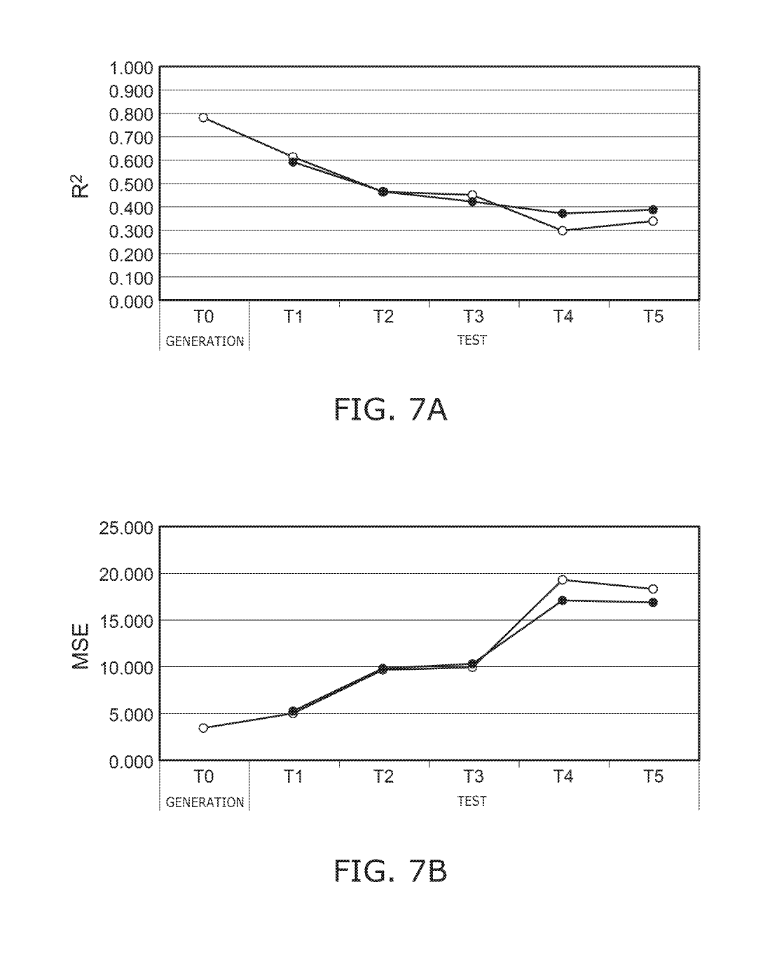

FIGS. 7A and 7B are graphs illustrating characteristics of the models generated using the model generation system 1 according to the embodiment.

The drawing illustrates R² for each interval. FIG. 7B illustrates the MSE for each interval.

Only the base model and the modified model having the highest generalization ability are illustrated in FIG. 7A and FIG. 7B. The results of the base model are illustrated by ◯ (the white circles). The results of the modified model having the highest generalization ability are illustrated by ● (the black circles).

From the results of FIG. 7A and FIG. 7B, it can be seen that the modified model has good accuracy and obtains a high R² and a small MSE similarly to those of the base model. The accuracy of the base model and the modified model decreases as the test interval moves into the future. For the test intervals T4 and T5, it can be seen that the decrease of the accuracy of the modified model is more gradual than the decrease of the accuracy of the base model; and the accuracy is higher. In other words, from this result, it can be seen that the modified model that is obtained by the embodiment has substantially the same accuracy as the base model. Further, compared to the base model, it can be seen that the modified model has a higher generalization ability and a higher accuracy for the variable data for a long period of time.

### Second Example

In a second example, the final quality of a workpiece after processing was used as the output variable of a manufacturing apparatus of an electronic device. The data (the temperature when processing, the pressure, etc.) of various sensors provided in the manufacturing apparatus was used as the input variables. The final quality was based on at least one of the dimension of the workpiece after the processing or the processing rate of the workpiece. The specified number was set to 1000. Adaptive Lasso was used for the selection of the multiple input variables and the generation of the base model. The correlation coefficient between the selected input variables and the unselected input variables was used as the similarity. The unselected input variables for which the correlation coefficient is not less than 0.5 were extracted and used to interchange the selected input variables at a uniform probability. After interchanging the selected input variables and the unselected input variables, a multiple regression was used to generate the models. Each model was generated based on the variable data for the prescribed generation interval T10. The variable data of the intervals of test intervals T11 to T13 after the generation interval T10 were used to calculate the generalization ability for the same manufacturing apparatus.

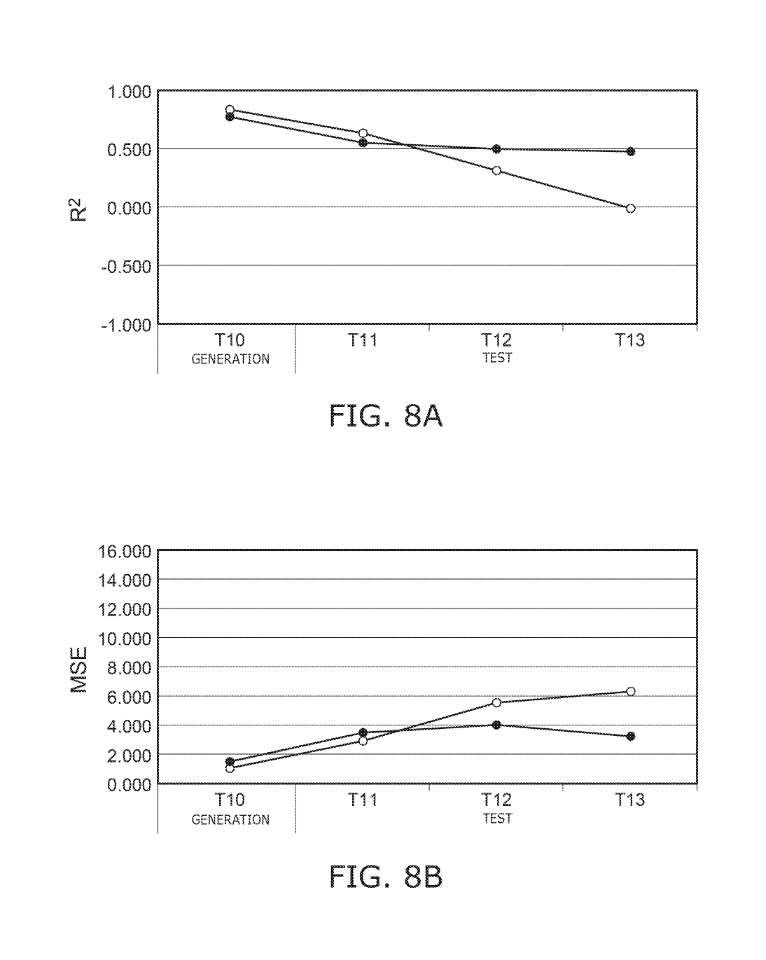

FIGS. 8A and 8B are graphs illustrating characteristics of the models generated using the model generation system 1 according to the embodiment.

FIG. 8A illustrates R² of each model for each interval. FIG. 8B illustrates the MSE for each model for each interval.

Only the base model and the modified model having the highest generalization ability are illustrated in FIG. 8A and FIG. 8B. The results of the base model are illustrated by ◯ (the white circles). The results of the modified model having the highest generalization ability are illustrated by ● (the black circles).

From the results of FIG. 8A and FIG. 8B, R² and the MSE of the base model respectively are substantially the same as R² and the MSE of the modified model when generating. In other words, the accuracy of the modified model is equal to the accuracy of the base model.

For the base model, R² decreases and the MSE increases as time elapses. Conversely, for the modified model, the decrease of R² stops from the interval T12 to the interval T13. Also, the MSE decreases from the interval T12 to the interval T13. These results show that the modified model has high accuracy; and the generalization ability of the modified model is higher than the generalization ability of the base model.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A model generation system, comprising:
a base model generator generating a base model of a relationship between an input variable group and an output variable, the input variable group including a plurality of selected input variables selected from a plurality of input variables;
a similarity calculator calculating each similarity between the plurality of selected input variables and a plurality of unselected input variables, the plurality of unselected input variables being included in the plurality of input variables and being different from the plurality of selected input variables;
a modified model generator interchanging, based on the plurality of similarities, at least a portion of the plurality of selected input variables with at least a portion of the plurality of unselected input variables so as to generate another input variable group, the modified model generator generating a modified model of a relationship between the output variable and the other input variable group; and
a generalization ability calculator calculating generalization abilities of the base model and the modified model.

2. The system according to claim 1, wherein each of the at least a portion of the plurality of unselected input variables has a similarity not less than a prescribed threshold with at least one of the plurality of selected input variables.

3. The system according to claim 2, wherein
the modified model generator generates an orthogonal table using experimental design, the orthogonal table relating to the plurality of selected input variables and the at least a portion of the plurality of unselected input variables,
the modified model generator generates a plurality of the modified models based on the orthogonal table,
the generalization ability calculator calculates a generalization ability of each of the plurality of modified models,
the modified model generator calculates, based on the calculation result of the plurality of generalization abilities, a main effect due to interchanging the variables, and
the modified model generator generates another modified model by interchanging, to maximize the main effect, at least a portion of the plurality of selected input variables with at least a portion of the plurality of unselected input variables having the largest main effect.

4. The system according to claim 1, wherein
the modified model generator sets, based on the plurality of similarities, each probability for respectively interchanging the plurality of selected input variables with the plurality of unselected input variables, and
the modified model generator generates the modified model by interchanging the at least a portion of the plurality of selected input variables with the plurality of unselected input variables according to the plurality of probabilities.

5. The system according to claim 1, further comprising an external outputter outputting, to the outside, the base model or the modified model having the highest calculated generalization ability.

6. A model generation method, comprising:
generating a base model of a relationship between an input variable group and an output variable, the input variable group including a plurality of selected input variables selected from a plurality of input variables;
calculating each similarity between the plurality of selected input variables and a plurality of unselected input variables;
interchanging, based on the plurality of similarities, at least a portion of the plurality of selected input variables with at least a portion of the plurality of unselected input variables so as to generate another input variable group;
generating a modified model of a relationship between the output variable and the other input variable group; and
calculating generalization abilities of the base model and the modified model.

7. The method according to claim 6, wherein each of the at least a portion of the plurality of unselected input variables has a similarity not less than a prescribed threshold with at least one of the plurality of selected input variables.

8. The method according to claim 7, further comprising:
generating an orthogonal table using experimental design, the orthogonal table relating to the plurality of selected input variables and the at least a portion of the plurality of unselected input variables;
generating a plurality of the modified models based on the orthogonal table;
calculating a generalization ability of each of the plurality of modified models;
calculating, based on the plurality of generalization abilities, a main effect due to interchanging the variables; and
generating another modified model by interchanging, to maximize the main effect, at least a portion of the plurality of selected input variables with at least a portion of the plurality of unselected input variables having the largest main effect.

9. The method according to claim 6, further comprising:
setting, based on the plurality of similarities, each probability for respectively interchanging the plurality of selected input variables with the plurality of unselected input variables; and
generating the modified model by interchanging the at least a portion of the plurality of selected input variables with the plurality of unselected input variables according to the plurality of probabilities.
